(19) United States
(12) Patent Application Publication
(10) Pub. No.: US 2002/0015639 A1
(43) Pub. Date: Feb. 7, 2002

(54) Horizontal axis wind turbine

(76) Inventor: Victor N. Roberts, Melville (CA)

Correspondence Address: KIRBY EADES GALE BAKER, P.O. Box 3432, Stn. D, Ottawa, ON, K1P 6N9, CA

(21) Appl. No.: 09/928,336

(22) Filed: Aug. 14, 2001

Related U.S. Application Data
(63) Continuation-in-part of application No. 09/633,195, filed on Aug. 4, 2000.

(51) Int. Cl. F03D 3/04

(52) U.S. Cl. 415/4.1

(57) ABSTRACT

A horizontal axis wind turbine is designed to operate under low wind velocities. It includes a substantially horizontal turntable frame mounted for rotation on a vertical pivot, a pair of laterally spaced vertical support legs fixed to and extending upwardly from the turntable frame and, a horizontal, rotatable shaft extending across between and horizontally journaled to the upper ends of the vertical support legs. A wind rotor is fixed to the rotatable shaft and includes at least four pairs of oppositely disposed arms radiating outwardly from the rotatable shaft with one or two concave surfaced wind catching bucket mounted across between each pair of arms. Each bucket is spaced outwardly along the arms at a distance at least twice the width of the bucket, and a wind direction vane is connected to the turntable frame for directing the wind rotor normal to the oncoming wind.

This invention relates to wind turbines and is a continuation-in-part of U.S. application Ser. No. 09/633,195 filed Aug. 4, 2000.

### FIELD OF THE INVENTION

### BACKGROUND OF THE INVENTION

Wind powered implements have been in use for hundreds of years and in the past a windmill was a common site on many farms for the pumping of water. There has been a growing interest in the use of wind power for the production of electricity. For instance, huge rotors on high towers are being developed which are very sophicated and expensive. These typically operate as a propeller on the horizontal axis.

There remains a need for a wind turbine for generating electricity which can be simple and inexpensive and, for instance, adapted for supplying the electrical needs of a single farm or rural home. Huther U.S. Pat. No. 4,037,989 describes a vertical axis wind turbine which includes a rotor with concave surfaced wind catching members. However, this design is poorly adapted to catch the maximum benefits of a particular wind direction.

Another relatively simple wind turbine, again with concave surfaced wind catching members, is shown in Forrest U.S. Pat. No. 4,357,130. This design is not effective at low wind speeds and is also not adapted for maximizing the effects of wind direction.

An attempt at a design at maximizing the effect of the wind using a horizontal axis rotor is shown in Hings U.S. Pat. No. 2,542,522. This rotor is designed to turn perpendicular to the wind and has a very complex mechanism for orienting a rotor blade where it is moving into the wind.

It is an object of the present invention to provide a horizontal axis wind turbine which is both efficient at low wind speeds and safe to operate at high wind speeds.

It is a further object of the invention to provide a wind turbine which can be effectively operated at close to ground level, thus avoiding the need for a high support tower.

### SUMMARY OF THE INVENTION

The present invention in its broadest aspect relates to a horizontal axis wind turbine which includes a substantially horizontal turntable frame mounted for rotation on a vertical pivot. A pair of laterally spaced vertical support legs are fixed to and extend upwardly from the turntable. A horizontal rotatable shaft extends across between and is horizontally journaled in the upper ends of these vertical support legs. A wind rotor is fixed to the rotatable shaft and comprises at least four, and preferably six, pairs of oppositely disposed arms radiating outwardly from the rotatable shaft with concave surfaced wind catching buckets mounted across between each pair of arms. Each bucket is spaced radially outwardly along the arms at a distance at least twice the width of the bucket. It has been found advantageous to mount two buckets between each pair of arms with a space between the buckets. A wind direction vane is also connected to the turntable frame for directing the wind rotor in a direction perpendicular to the oncoming wind.

According to a preferred feature of the invention, an upwardly inclined wind deflecting panel is mounted on the turntable frame and is designed to deflect the oncoming wind in an upwardly inclined direction into the wind catching buckets. This wind deflecting panel also serves to shield the lower buckets that are moving upwardly from being affected by the wind until each bucket rises above the upper end of the panel.

A typical rotor has a diameter of about 10-30 feet and the pairs of rotor arms are typically spaced from each other by a distance of about 3-6 feet. Each bucket fits between the pairs of arms and has a width of about 2-3 feet when a single bucket is used. These concave buckets typically have a depth of about 1-2 feet. When a pair of spaced buckets are used, each has a width of about 1-2 feet and are spaced by a distance of about 1.5-2.5 feet.

This design of rotor is rather slow turning, but is very effective in collecting the existing winds. For instance, it can be operated successfully at wind speeds as low as 7 mph and can also operate safely with winds of 40 mph. With a 7 mph wind, rotor turns at less than one revolution per second, while with a 40 mph wind the rotor turns at a speed of about 1-2 revolutions per second. To utilize this for generating electricity, it is evident that the speed must be greatly amplified. For that reason, the electrical generator is driven through a gear box which steps up the rpm created by the rotor by at least 50-75 times.

According to a further feature of the invention, a second rotor is used mounted on a vertical axis. This is mounted beside the rotor on the horizontal axis and the two rotors are gear-connected in such a manner that the arms of the two rotors inter-mesh without actually touching. This arrangement of two inter-meshing rotors serves to reduce air drag and make the system more efficient. The two rotors are mounted on the same base and thus move into the wind together.

### BRIEF DESCRIPTION OF THE DRAWINGS

Certain preferred features of the present invention are illustrated by the attached drawings in which:

FIG. 1 is a perspective view of the full assembly,

FIG. 2 is a side elevation of the assembly shown in FIG. 1,

FIG. 3 is an end elevation of the assembly shown in FIG. 2,

FIG. 4 is an elevation view of a preferred arrangement of buckets,

FIG. 5 is a perspective view of a double rotor system of the invention, and

FIG. 6 is an elevation view of the double rotor system of FIG. 5.

### DESCRIPTION OF THE PREFERRED EMBODIMENTS

As shown in the above drawings, the wind turbine of this invention includes a substantially horizontal turntable frame 10 mounted for rotation on a mast 25. The lower end of this pivot is anchored to a solid ground support member 26. The pivot comprises an inner post fixed to support member 26 and an outer sleeve fixed to the turntable frame 10. The turning surfaces include ball bearings for ease of rotation.

Extending upwardly from each side of the turntable 10 are a pair of vertical support legs 11 which are fixed by means of angle braces 12. Fixed to the upper ends of these arms 11 are bearing journals 13 for receiving a horizontal rotatable shaft 14. The wind rotor is fixed to this rotatable shaft 14 and comprises six pairs of radially extending arms 16. Mounted across between each pair of arms 16 is a concave surfaced wind catching bucket 17. It is important that the bucket 17 be mounted distally from the shaft 14 and in a particularly preferred embodiment the arms 16 have a length of 8 feet and a lateral spacing of 4.5 feet. Each bucket has a width of 2.5 feet and a depth of 1.5 feet. This means that there is 5.5 feet of free space between the rotatable shaft 14 and the inner edge of each bucket 17. In order to stabilize this assembly, cross braces 18 are provided between the arms 16 in the free space region between the rotatable shaft 14 and the buckets 17.

With the particular dimensions given above, each bucket has an area of about 11 square feet. At any one time during a rotation, two of the buckets are fully exposed to the force of the wind for a total exposure to the wind of about 22 square feet.

A gear box and electrical generator assembly 15 is attached to the upper end of leg 11. As mentioned above, the gear box is designed to step up the rpm of the rotatable shaft 14 by at least 50-75 times.

A wind direction vane is used for directing the rotor normal to the oncoming wind. This wind vane 21 is mounted on one end of the turntable frame 10 by means of support legs 20.

On the upwind end of the turntable frame 10 is mounted a wind deflecting panel 22. This panel is supported at the upper end by means of support legs 23 and is mounted on the turntable 10 at an angle of about 35° to the horizontal. The upper end of the deflector panel 22 is preferably located at an elevation approximately equal to the elevation of the rotatable shaft 14 and directs the wind in an upward direction into the rising buckets as they pass the top end of the deflector. The deflector panel can increase the rotor speed by 15-20% for a given wind speed.

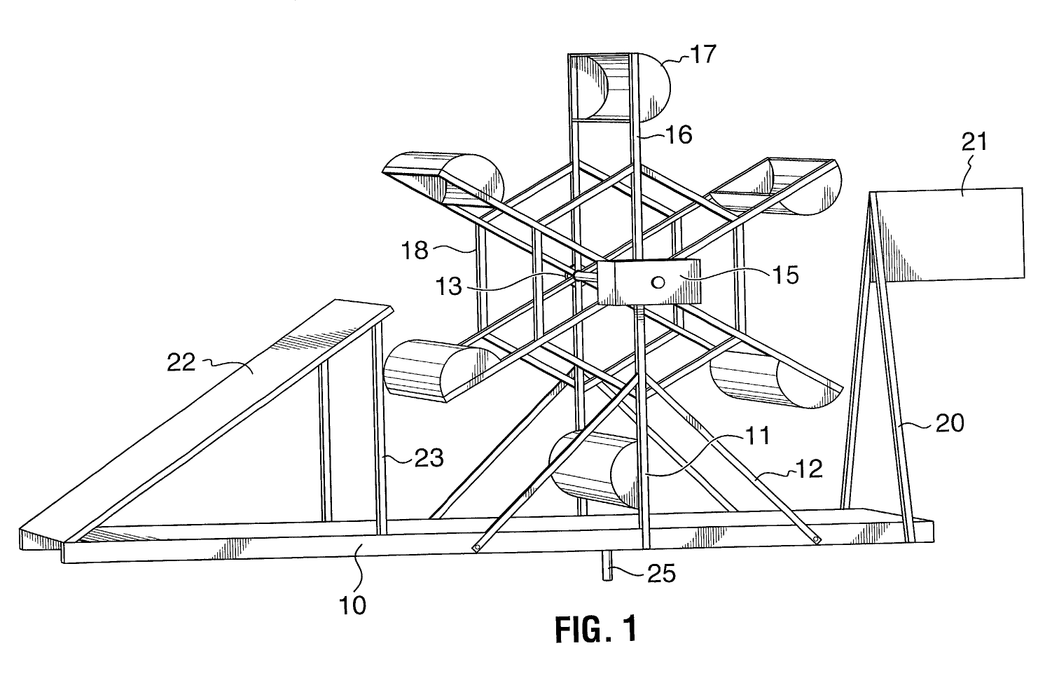

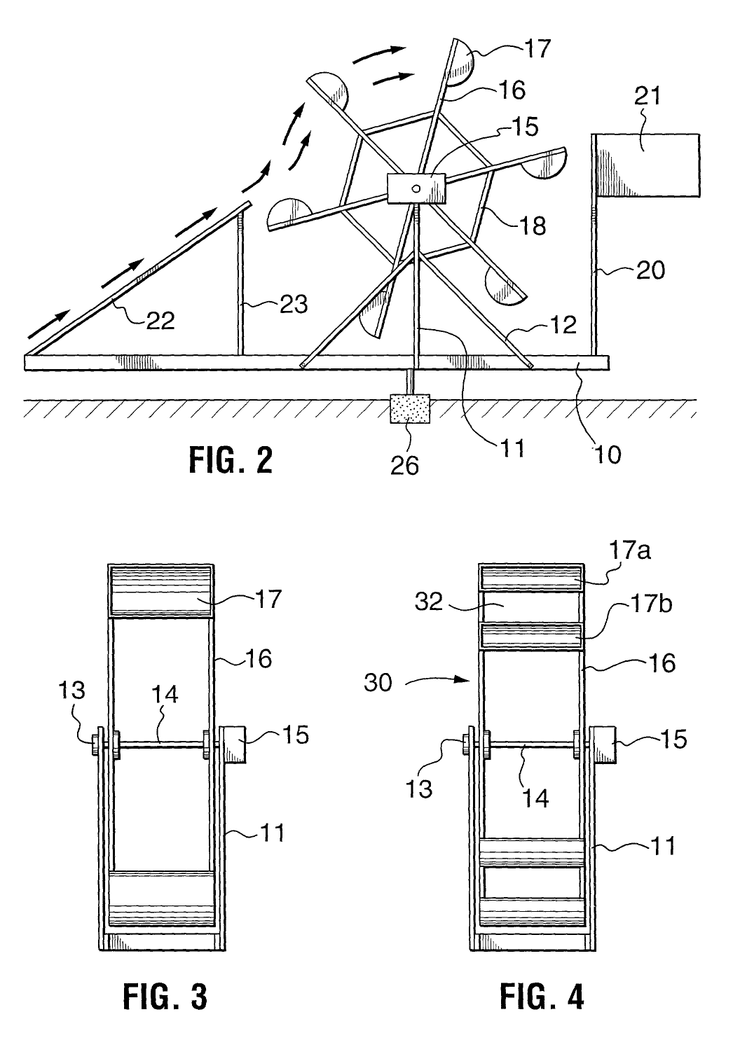

A preferred arrangement of wind catching buckets is shown in FIG. 4. In this arrangement, a pair of spaced wind catching buckets 17a and 17b are used between the arms 16 with an air gap 32 between them. In a preferred arrangement each bucket has a width of about 1.5 feet and a length of about 4.5 feet with a gap 32 width of about 2 feet. This has been found to be more efficient than the single bucket as shown in FIGS. 1-3. The pair of spaced buckets provides less air drag and produces greater energy for a given wind velocity.

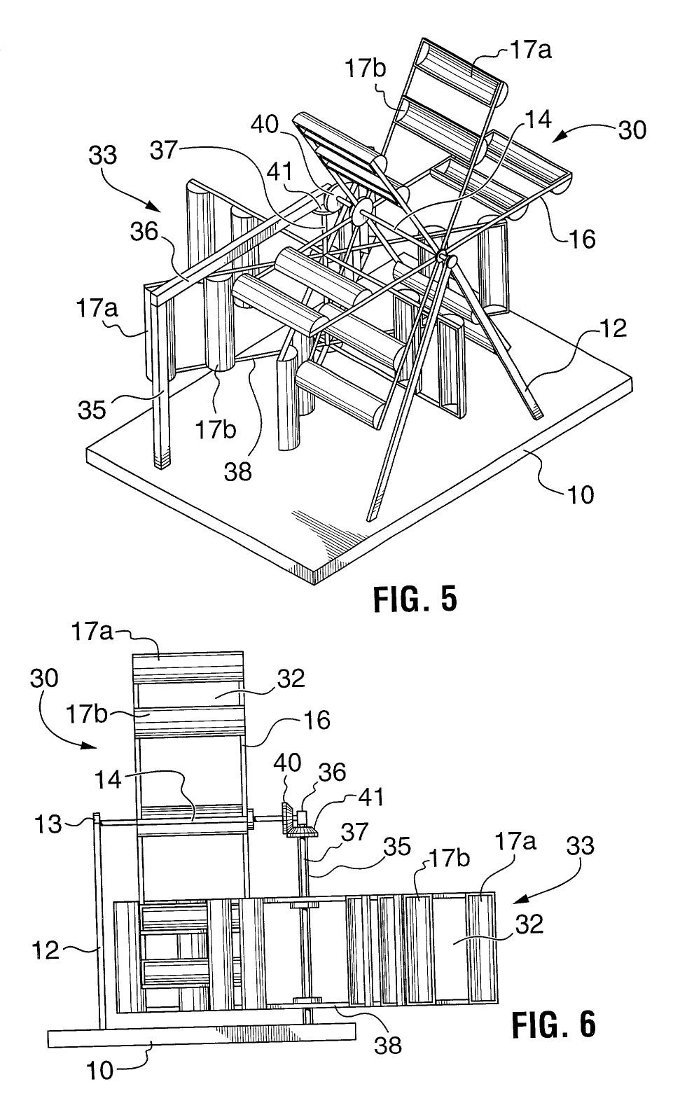

Another preferred embodiment of the invention is shown in FIG. 5. This includes a rotor 30 mounted on horizontal rotatable shaft 14 as shown in FIG. 5 in combination with a second rotor 33 mounted on a vertical rotatable shaft 37. A vertical support 35 and a horizontal support 36 carry one end of horizontal rotatable shaft 14 of rotor 30 and the upper end of the vertical rotatable shaft 37 of the second rotor 33. The rotor 33 includes radial arm 38 supporting pairs of wind catching buckets 17a and 17b in a manner similar to rotor 30.

The two rotors 30 and 33 are arranged to inter-mesh in a coordinated fashion such that a pair of radial arms 38 of rotor 33 pass between two adjacent pairs of radial arms of rotor 30 at the bottom of the rotation of rotor 30 as shown in FIG. 5. This is accomplished by means of the bevel pinion gears 40 and 41 connected to shafts 14 and 37 respectively as shown in FIG. 6. The electrical generator may still be connected to rotor 30 with power to drive the generator being provided by the joint action of the two rotors 30 and 33.

A particular advantage of the wind turbine of this invention is that it can efficiently utilize even quite low wind speeds in the order of 7 mph without the need for being mounted on a high tower or mast. Accordingly, the turntable frame 10 need only clear the ground sufficient to avoid interference from anything that collects on the ground, e.g. snow. While the drawings show the turntable quite close to the ground, it is generally preferred to use a mast 25 having a height of about 10-15 feet.

It will therefore be seen that the wind turbine assembly of this invention represents a simple and easy design which, at the same time, is capable of efficiently utilizing even low wind speeds for the generation of electricity. It is also to be understood that the described exemplary embodiments of the apparatus of this invention are intended for the purpose of illustration only, and that the principles of the invention are not to be limited thereto, except as defined in the appended claims.

1. A horizontal axis wind turbine which comprises in combination a substantially horizontal turntable frame mounted for rotation on a vertical pivot, a pair of laterally spaced vertical support legs fixed to and extending upwardly from said turntable frame, a horizontal, rotatable shaft extending across between and horizontally journaled to the upper ends of the vertical support legs, a wind rotor fixed to said rotatable shaft and comprising at least four pairs of oppositely disposed arms radiating outwardly from the rotatable shaft with concave surfaced wind catching buckets mounted across between each pair of arms, said buckets being spaced outwardly along the arms at a distance at least twice the width of the bucket, and a wind direction vane connected to the turntable frame for directing the wind rotor normal to the oncoming wind.

2. A wind turbine as claimed in claim 1 wherein the rotor has six pairs of oppositely disposed arms.

3. A wind turbine as claimed in claim 2 having a single wind catching bucket mounted across between each pair of arms.

4. A wind turbine as claimed in claim 2 having two wind catching buckets mounted across between each pair of arms, with a space between the buckets.

5. A wind turbine as claimed in claim 1 which also includes an upwardly inclined wind deflector connected to the turntable for deflecting the oncoming wind into the wind catching buckets.

6. A wind turbine as claimed in claim 2 wherein the rotor has a diameter of about 10-30 feet.

7. A wind turbine as claimed in claim 6 wherein each pair of rotor arms are laterally spaced from each other by a distance of about 3-6 feet.

8. A wind turbine as claimed in claim 3 wherein each wind catching bucket has a length of about 3-6 feet and a width of about 2-3 feet.

9. A wind turbine as claimed in claim 8 wherein each wind catching bucket has a depth of about 1-2 feet.

10. A wind turbine as claimed in claim 4 wherein each wind catching bucket has a length of about 3-6 feet and a width of about 1-2 feet, with a space of about 1.5-2.5 feet therebetween.

11. A wind turbine as claimed in claim 4 which comprises a second wind rotor mounted on a vertical axis and having radial arms with wind catching buckets adapted to inter-mesh with the radial arms of the said wind rotor mounted on the horizontal axis.

12. A wind turbine as claimed in claim 11 wherein both wind rotors are mounted on a common base with the vertical rotor shaft and the horizontal rotor shaft being operatively connected by means of bevelled pinion gears.

13. A wind turbine as claimed in claim 1 wherein the turntable is mounted on a vertical pivot at a distance above the ground of at least about 10 feet.

14. A wind turbine as claimed in claim 11 wherein the turntable is mounted on a vertical pivot at a distance above the ground of at least about 10 feet.

15. A wind turbine as claimed in claim 1 which includes an electricity generator driven through a gear box adapted to increase the rotational speed generated by the rotor by at least 50-75 times.

16. A wind turbine as claimed in claim 11 which includes an electricity generator driven through a gear box adapted to increase the rotational speed generated by the rotor by at least 50-75 times.

17. A wind turbine as claimed in claim 15 wherein the rotor is adapted to rotate at a maximum speed of about one revolution per second.
